(19) United States
(12) Patent Application Publication
(10) Pub. No.: US 2021/0162854 A1
(43) Pub. Date: Jun. 3, 2021

(54) Hybrid gear mechanism, hybrid drive assembly and method for operating a hybrid drive assembly

(71) Applicant: Schaeffler Technologies AG & Co. KG, Herzogenaurach (DE)

(72) Inventors: Steffen Lehmann, Ettlingen (DE); Andreas Trinkenschuh, Bühl (DE); Laurent Bayoux, Strasbourg (FR)

(73) Assignee: Schaeffler Technologies AG & Co. KG, Herzogenaurach (DE)

(21) Appl. No.: 17/262,979

(22) PCT Filed: Jun. 27, 2019
(86) PCT No.: PCT/DE2019/100599

§ 371 Date: Jan. 25, 2021

(30) Foreign Application Priority Data
Jul. 26, 2018 (DE) 10 2018 118 114.0
Sep. 26, 2018 (DE) 10 2018 123 740.5

(51) Int. Cl. B60K 6/442; B60K 6/40; B60W 20/40; B60W 20/13; B60W 20/20

(52) U.S. Cl. CPC B60K 6/442; B60K 6/40; B60K 2006/4825; B60W 20/13; B60W 20/20; B60W 20/40

(57) ABSTRACT

A hybrid gear mechanism comprises a connection device for coupling to an internal combustion engine, a disconnect clutch, a first electrical machine, a first clutch device and an output drive device of said hybrid gear mechanism, which are all interconnected in series, said connection device being mechanically coupled to the input side of the disconnect clutch, the output side of the disconnect clutch being coupled to a rotor of the first electrical machine, the rotor of the first electrical machine being coupled to the input side of the first clutch device, and the output side of the first clutch device being coupled to the output drive device of the hybrid gear mechanism.

### CROSS-REFERENCE TO RELATED APPLICATIONS

This application is the U.S. National Phase of PCT Appln. No. PCT/DE2019/100599 filed Jun. 27, 2019, which claims priority to DE 102018118114.0 filed Jul. 26, 2018 and DE 102018123740.5 filed Sep. 26, 2018, the entire disclosures of which are incorporated by reference herein.

### TECHNICAL FIELD

The disclosure relates to a hybrid gear mechanism, a hybrid drive assembly comprising the hybrid gear mechanism, and a method for operating said hybrid drive assembly.

### BACKGROUND

Hybrid drive units which include two electrical machines and at least one clutch device are known from the prior art. In this case, a clutch device, in particular a disconnect clutch, is arranged between an electrical machine and an output element of an internal combustion engine. Such an arrangement is also referred to as a P2 arrangement. Since the internal combustion engine can be decoupled from the rest of the drive train, a purely electric drive through the other electrical machine as well as recuperation without loss of power due to the drag torque of the internal combustion engine can be implemented. Different clutch devices such as dual clutch devices can be implemented.

Known hybrid drive systems comprise two electrical machines and a transmission, wherein a clutch device is arranged between one of the electrical machines and the transmission in order to couple or uncouple this electrical machine. In such an embodiment, the transmission is often an automatic transmission or a dual clutch transmission. The choice of transmission can also depend on the design of the electrical machine. For example, given a correspondingly high power of an electrical machine configured to drive the motor vehicle, which can thus be operated in a large speed range, it is not absolutely necessary for the transmission to form a plurality of transmission stages.

Drive arrangements are also known which include two electrical machines, a transmission unit, a disconnect clutch and further clutch devices and an internal combustion engine in order to implement a wide variety of driving modes for a motor vehicle. The two electrical machines are designed for different power outputs. The electrical machine with higher power is used as a drive unit. The electrical machine with lower power has a negligible drag torque and is accordingly preferably used for the recuperation of electrical energy.

Furthermore, so-called power-split hybrids are also known from the prior art.

In particular, for requirements of increased sportiness of the vehicle to be driven or increased off-road capability, it may be necessary to drive several axles of the motor vehicle.

### SUMMARY

Proceeding from this, the object of the present disclosure is to provide a hybrid gear mechanism, a hybrid drive assembly and a method for operating a hybrid drive assembly with which a wide variety of operating or driving states of the motor vehicles equipped with the hybrid gear mechanism or the hybrid drive assembly can be implemented in a simple, cost-effective and space-saving manner.

This object is achieved by the hybrid gear mechanism, the hybrid drive assembly and the method for operating a hybrid drive assembly described herein and in the accompanying claims.

Advantageous embodiments of the hybrid gear mechanism and of the hybrid drive assembly are described herein and in the accompanying claims.

The features of the claims may be combined in any technically useful way, including the explanations given in the following description and features of the figures which comprise additional embodiments of the disclosure.

In a first aspect, the disclosure relates to a hybrid gear mechanism, comprising a connection device for coupling to an internal combustion engine, a disconnect clutch, a first electrical machine, a first clutch device and an output drive device of the hybrid gear mechanism, which are interconnected in series. The connection device is mechanically coupled to the input side of the disconnect clutch, and the output side of the disconnect clutch is coupled to a rotor of the first electrical machine. The rotor of the electrical machine is coupled to the input side of the first clutch device, and the output side of the first clutch device is coupled to the output drive device of the hybrid gear mechanism. Preferably, only one electrical machine is arranged in the hybrid gear mechanism according to the disclosure.

A differential gear can be arranged on the output drive device, or the output drive device can be formed by this output drive device.

The disconnect clutch, the first electrical machine and the first clutch device thus define a first torque transmission path between the connection device and the output drive device.

This makes it possible to implement the following operating states:
charging a battery when a motor vehicle equipped with the hybrid drive assembly is stationary, wherein the internal combustion engine is operated, the disconnect clutch is closed and the first electrical machine driven by the internal combustion engine is operated as a generator and the electrical energy generated thereby is supplied to a battery for the purpose of storage,
serial operation, in which the internal combustion engine is operated, the disconnect clutch is closed and the first electrical machine is operated as a generator, and the electrical energy generated thereby is supplied to the second electrical machine for the purpose of driving the motor vehicle,
purely electric motor drive, in which the first electrical machine is operated as an electric motor drive and the first clutch device is closed,
recuperation operation, in which the output drive device of the hybrid gear mechanism is driven by the kinetic energy of the motor vehicle equipped with the hybrid drive assembly, the first clutch device is closed and the first electrical machine is operated as a generator, and
sole drive by the internal combustion engine, in which a motor vehicle equipped with the hybrid drive assembly is driven by the internal combustion engine, wherein the disconnect clutch and the first clutch device is closed.

In one embodiment, it is provided that on the axle of the motor vehicle to be driven, on which the hybrid gear mechanism acts, only one electrical machine is operated in cooperation with an internal combustion engine in the hybrid gear mechanism. The arrangement or use of a further electrical machine in the hybrid gear mechanism on the axle driven by the hybrid gear mechanism should not be ruled out, provided that it has a significantly lower nominal power compared to the first electrical machine provided according to the disclosure and consequently does not make a significant contribution to the drive power of a motor vehicle equipped with the hybrid gear mechanism.

In one embodiment of the hybrid gear mechanism according to the disclosure, it is provided that the hybrid gear mechanism furthermore has a second clutch device which is arranged in a second torque transmission path running in parallel to the first torque transmission path, which is defined by the disconnect clutch, the first electrical machine and the first clutch device.

Correspondingly, an input side of the second clutch device is coupled to the connection device for connection to an internal combustion engine, and the output side of the second clutch device is coupled to the output drive device of the hybrid gear mechanism.

This means that further operating states can be implemented, specifically:
parallel operation, in which a motor vehicle equipped with the hybrid drive assembly is driven by means of the internal combustion engine, and the disconnect clutch and the first clutch device and/or second clutch device are closed, so that the motor vehicle equipped with the hybrid drive assembly is partly driven by the internal combustion engine, and the motor vehicle is partly driven by the first electrical machine as a further drive motor,
operation with load point shifting, in which a motor vehicle equipped with the hybrid drive assembly is driven by the internal combustion engine, and the disconnect clutch and the first clutch device and/or second clutch device are closed and the first electrical machine driven by the internal combustion engine is operated as a generator, and the electrical energy generated thereby is supplied to the battery for storage, and
sole drive by the internal combustion engine, in which a motor vehicle equipped with the hybrid drive assembly is driven by the internal combustion engine, wherein the second clutch device is closed.

At least one of the above-mentioned clutches or clutch devices can be designed as a multi-plate clutch, preferably as a wet-running multi-plate clutch.

In a further embodiment, a first transmission stage is arranged in the first torque transmission path between the first clutch device and the output drive device, and a second transmission stage is arranged in the second torque transmission path between the second clutch device and the output drive device, wherein the second transmission stage implements a different transmission ratio than the first transmission stage.

As a result, different torques or speeds can be achieved on the output drive device in the operating states of “parallel operation” and “operation with load point shifting”, depending on the closure of a respective clutch device and consequently actuation of a respective transmission stage coupled to the respective clutch device.

The transmission ratio implemented with the second transmission stage is preferably significantly greater, at least 1.5 times greater, than the transmission ratio achieved by the first transmission stage.

At least one of the transmission stages is advantageously designed as a spur gear set. This enables the hybrid gear mechanism to be designed substantially without claws or synchronizing elements and the actuators required therefor.

The output drive element itself can be a differential gear. The differential gear connects the drive shafts of the wheels of the axle driven by the hybrid gear mechanism, in particular the front axle.

Furthermore, for the purpose of a compact design of the hybrid gear mechanism, it is preferably provided that the two clutch devices are partial clutches of a dual clutch device.

For a further volume-saving design of the hybrid gear mechanism, it is provided that at least two of the three clutches, namely the disconnect clutch, the first clutch device and the second clutch device, are arranged at least in some areas in the axial direction, in relation to the axis of rotation of the rotor of the first electrical machine, within a space which is radially enclosed by the rotor of the first electrical machine.

Another aspect of the present disclosure is a hybrid drive assembly which has a hybrid gear mechanism, wherein the hybrid gear mechanism is assigned to a first axle of a motor vehicle to be driven, and has a second electrical machine, which is assigned to a second axle and is electrically conductively connected to the first electrical machine in such a way that the second electrical machine can be operated at least indirectly by electrical energy generated by means of the first electrical machine.

By means of the hybrid gear mechanism, torque can thus be applied to the first axle assigned thereto.

The operation of the second electrical machine can be implemented in that the second electrical machine is connected directly to the first electrical machine, i.e., without the interposition of a power storage device, so that electrical energy generated by the first electrical machine can be converted in the second electrical machine for the purpose of driving it.

Alternatively or additionally, the second electrical machine can also be connected to the first electrical machine via a power storage device, such as a battery of a hybrid vehicle, so that electrical energy generated by the first electrical machine can first be stored in the power storage device and therefrom be supplied to the second electrical machine for the purpose of driving it.

Embodiments disclosed herein can thus be used for a configuration with two driven vehicle axles. With the option of driving the front axle or the rear axle or both axles at the same time, it is possible to select which axle is driven. As a result, the axle on which there is an increased torque requirement can be operated accordingly, such as when using snow chains.

Despite rear-wheel drive, a Cardan shaft is not necessary, instead only an electrical machine that is relatively small in terms of its structural volume, such as an electric axle.

The drive implemented on the front axle only requires a very small transmission with only two transmission ratios in order to be able to cover the desired speed range or torque range, since the internal combustion engine and the first electrical machine can be operated together in an optimal manner.

At the same time, fuel-saving operation is possible, since when the internal combustion engine is operated with the first electrical machine operating as a generator and the associated conversion of mechanical energy into electrical energy, it can be operated with an overall high degree of efficiency.

The use of the hybrid gear mechanism according to the disclosure is not limited to the interaction with a second, electric motor-driven axle, but the proper hybrid gear mechanism can also be used in motor vehicles without a second, electric motor-driven axle and implement the operating states mentioned in this regard, such as in a simple P2 design or as a range extender.

The second electrical machine can in particular be designed as an electric drive axle, preferably on the rear axle of a motor vehicle.

At least one of the two electrical machines can be oil-cooled or water-cooled. The cooling processes within the hybrid gear mechanism and in particular the clutches or clutch devices can be controlled, in particular, by means of electrical pump actuators.

Furthermore, at least one of the two electrical machines can have power electronics that are positioned in or on a housing of the hybrid gear mechanism.

In a further embodiment, the hybrid drive assembly comprises an internal combustion engine, the output drive of which is mechanically coupled to the connection device of the hybrid gear mechanism.

Optionally, a vibration damper can also be arranged between the internal combustion engine and the hybrid gear mechanism and consequently at the input of the hybrid gear mechanism. This vibration damper is preferably a bow spring damper with a centrifugal pendulum.

The present disclosure also relates to a method for operating the hybrid drive assembly in one of the following operating states:
i) Charging a battery when a motor vehicle equipped with the hybrid drive assembly is stationary:
   In this case, the internal combustion engine is operated, the disconnect clutch is closed and the first electrical machine driven by the internal combustion engine is operated as a generator and the electrical energy generated thereby is supplied to a battery for the purpose of storage.
ii) Serial operation:
   In this case, the internal combustion engine is operated, the disconnect clutch is closed and the first electrical machine is operated as a generator, wherein the electrical energy generated thereby is supplied to the second electrical machine for the purpose of driving the motor vehicle.
   In the serial operation operating state, the second clutch device is opened, since the operation of the internal combustion engine only serves to drive the first electrical machine operated as a generator, but the actual drive of the motor vehicle is carried out by means of the second electrical machine, preferably on the rear-wheel axle. It should not be ruled out here that electrical energy generated proportionally by the first electrical machine is supplied to the battery for the purpose of storage.
iii) Parallel operation:
   In this case, a motor vehicle equipped with the hybrid drive assembly is driven by means of the internal combustion engine, and the disconnect clutch and the first clutch device and/or second clutch device are closed, so that the motor vehicle equipped with the hybrid drive assembly is partly driven by the internal combustion engine, and the motor vehicle is partly driven by the first electrical machine as a further drive motor.
   In the parallel operation operating state, one of the two clutch devices is closed in order to use the drive torque of the internal combustion engine to drive the vehicle.
   In the case of parallel operation, by selecting the respective torque transmission path and the first or second transmission stage arranged therein, the operation can accordingly be implemented with the output of a high torque and relatively low rotational speeds, as required, for example, when starting a motor vehicle, or can be implemented with the output of a relatively low torque and high rotational speeds, such as for highway driving.
iv) Operation with load point shifting:
   In this case, a motor vehicle equipped with the hybrid drive assembly is driven by the internal combustion engine, and the disconnect clutch and the first clutch device and/or second clutch device are closed and the first electrical machine driven by the internal combustion engine is operated as a generator, wherein the electrical energy generated thereby is supplied to the battery for the purpose of storage.
   In operation with load point shifting, at least one of the two clutch devices is closed in order to use the drive torque of the internal combustion engine to drive the vehicle.
   In addition, load point shifting can be influenced by the selection of the use of a respective torque transmission path with an integrated transmission stage.
   Load point shifting enables the internal combustion engine to be operated with simultaneous drive of the first electrical machine operated as a generator with a very high degree of efficiency and consequently in a very fuel-saving and emission-saving manner.
v) Purely electric motor drive:
   In this case, the first electrical machine is operated as an electric motor drive and the first clutch device is closed.
   In this purely electric drive, it should not be ruled out that, in addition to the first electrical machine, the second electrical machine is also used to drive the motor vehicle.
vi) Recuperation operation:
   In this case, the output drive device of the hybrid gear mechanism is driven by the kinetic energy of the motor vehicle equipped with the hybrid drive assembly, the first clutch device is closed, and the first electrical machine is operated as a generator.
   In recuperation operation, the electrical energy obtained can be stored in the battery of the motor vehicle.
   Furthermore, recuperation operation can also be used to brake the motor vehicle by means of the torque to be overcome in the first electrical machine.
vii) Sole drive by the internal combustion engine:
   In this case, a motor vehicle equipped with the hybrid drive assembly is driven by the internal combustion engine, wherein the disconnect clutch and the first clutch device or the second clutch device is closed.
   With sole drive by the internal combustion engine, either the disconnect clutch and the first clutch device are closed in order to bring the torque from the internal combustion engine to the axle of the motor vehicle, or only the second clutch device is closed, which is the preferred variant for a purely internal combustion engine drive.

In the “parallel operation” and “operation with load point shifting” operating states, the motor vehicle equipped with the hybrid drive assembly according to the disclosure can be driven in different transmission stages depending on the use of a respective torque transmission path via the first clutch device or the second clutch device and transmission stages connected behind. In particular, the first transmission stage in the first torque transmission path can be used for starting or if an increased torque is generally required on the driven wheels.

For higher speeds and a higher speed range, it is recommended to use the second torque transmission path with the second transmission stage integrated therein.

The following is a summary of the different operating modes, where i1 denotes the first transmission stage and i2 denotes the second transmission stage.

| | | | First | Second |
|---|---|---|---|---|
| | Transmission | Disconnect | clutch | clutch |
| Operating state | stage | clutch | device | device |
| Charging a battery | | Closed | | |
| while stationary | | | | |
| Serial operation | | Closed | | |
| Parallel operation | i1 | Closed | Closed | |
| Parallel operation | i2 | Closed | | Closed |
| Operation with load | i1 | Closed | Closed | |
| point shifting | | | | |
| Operation with load | i2 | Closed | | Closed |
| point shifting | | | | |
| Purely electric | | | Closed | |
| motor drive | | | | |
| Recuperation | | | Closed | |
| operation | | | | |
| Sole drive by the | | | | Closed |
| internal combustion | | | | |
| engine | | | | |

### BRIEF DESCRIPTION OF THE DRAWINGS

The disclosure described above is explained in detail below based on the relevant technical background with reference to the associated drawings, which show preferred embodiments. The disclosure is in no way restricted by the purely schematic drawings, although it should be noted that the embodiments shown in the drawings are not limited to the dimensions shown. In the drawings:

FIG. 1: shows a hybrid gear mechanism according to embodiments of the disclosure in a schematic view,

FIG. 2: shows a hybrid gear mechanism according to embodiments of the disclosure in a detailed view, and

FIG. 3: shows a hybrid drive assembly according to embodiments of the disclosure in a schematic view.

### DETAILED DESCRIPTION

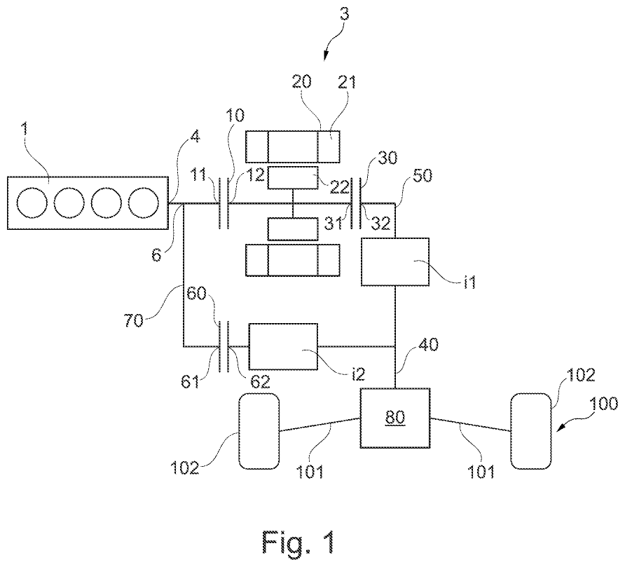

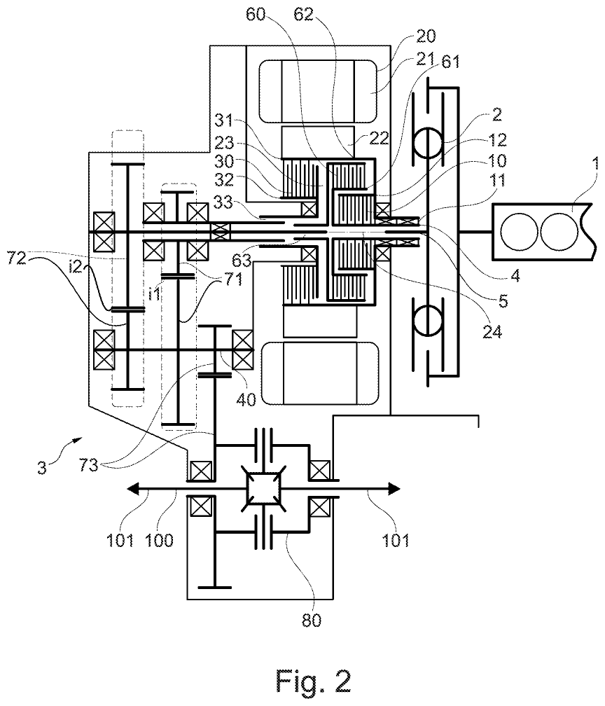

First, the structure of the hybrid gear mechanism according to the disclosure is explained with reference to FIGS. 1 and 2.

The hybrid gear mechanism 3 comprises a connection device 4 for connection to a vibration damper 2, which in turn is connected non-rotatably to the output of an internal combustion engine 1.

The connection device 4 is non-rotatably connected to the input side 11 of a disconnect clutch 10 via a first spline 5 shown in FIG. 2. The output side 12 of the disconnect clutch 10 is in turn coupled non-rotatably to the rotor 22 of a first electrical machine, which is rotatably mounted about an axis of rotation 24 within the stator 21 of the first electrical machine.

The rotor 22 of the first electrical machine 20 is furthermore non-rotatably coupled to the input side 31 of a first clutch device 30. The output side 32 of the first clutch device 30 is coupled to a first transmission stage it via a second spline 33 shown in FIG. 2.

As can be seen from FIG. 2, the first transmission stage i1 is formed by a first gearwheel pair 71 made up of two spur gears, which implements a first transmission ratio.

An output drive device 40 is coupled to the output of the first transmission stage it for outputting the torque generated by the internal combustion engine 1 or the first electrical machine 20.

The hybrid gear mechanism 3 according to the disclosure thus implements a first torque transmission path 50 from the connection device 4 to the output drive device 40.

As can be seen in particular from FIG. 1, the hybrid gear mechanism 3 furthermore comprises a branch 6 to which the input side 61 of a second clutch device 60 is connected. The output side 62 of the second clutch device 60 is connected to a second transmission stage i2, which in turn is coupled to the output drive device 40.

In particular, FIG. 2 shows that the output side 62 of the second clutch device 60 is non-rotatably coupled to the second transmission stage i2 by means of a third spline 63.

The hybrid gear mechanism 3 thus forms a second torque transmission path 70 between the connection device 4 and the output drive device 40 via the second clutch device 60 and the second transmission stage i2.

As can be seen from FIG. 2, the second transmission stage i2 is formed by a second gearwheel pair 72 made of two spur gears, which implements a second transmission ratio. Based on the size ratios of the two gear wheel pairs 71, 72, it can be seen that the second transmission stage i2 implements a greater transmission ratio than the first transmission stage i1.

In addition, it can be seen in FIG. 2 that both the disconnect clutch 10 and the two clutch devices 30, 60 are arranged in a space-saving manner completely within a space 23 radially enclosed by the rotor 22 of the first electrical machine 20. The disconnect clutch 10 and the second clutch device 60 are arranged radially nested inside one another.

Furthermore, FIG. 2 shows that the output drive device 40 is connected in a rotationally fixed manner to a third gearwheel pair 73, which transmits a rotary movement generated by the hybrid gear mechanism 3 to a connected differential gear 80. The differential gear 80 distributes the rotary movement or the applied torque to the two drive shafts 101 of a first axle 100, on which, as shown in FIG. 1, wheels 102 of a motor vehicle are arranged.

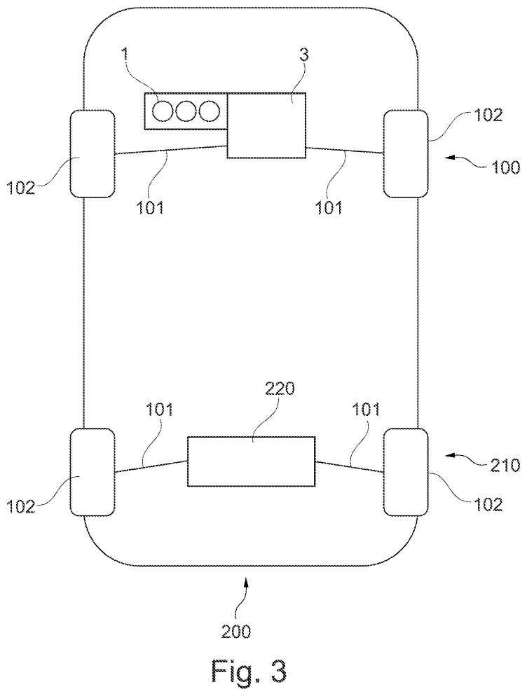

In FIG. 3, in the illustrated hybrid drive assembly 200 according to the disclosure, the hybrid gear mechanism 3 is also illustrated with a first axle 100 connected thereto as a front axle with drive shafts 101 and wheels 102.

It can be seen that a motor vehicle equipped therewith could already be driven solely with the hybrid gear mechanism 3 according to the disclosure.

The hybrid drive assembly 200 also provides a second axle 210, here designed as a rear axle, the drive shafts 101 of which are coupled to a second electrical machine 220, which is preferably designed as an electrical drive axle.

The hybrid gear mechanism 3 or the hybrid drive assembly 200 can be operated in different modes.

When a motor vehicle equipped with the hybrid drive assembly 200 is stationary, the internal combustion engine 1 is operated and the disconnect clutch 10 is closed, so that the first electrical machine 20 is driven by the internal combustion engine 1 and operated as a generator. The electrical energy thus generated is preferably supplied to a battery (not shown here) for the purpose of storage.

In so-called “serial operation”, the internal combustion engine 1 is also operated, the disconnect clutch is closed and the first electrical machine is operated as a generator, wherein in this operating mode, however, the electrical energy generated thereby is supplied to the second electrical machine 200 for the purpose of driving the motor vehicle.

In so-called “parallel operation”, a motor vehicle 1 equipped with the hybrid drive assembly 200 is driven by means of the internal combustion engine, wherein the disconnect clutch 10 and the first clutch device 30 and/or second clutch device 60 are closed, so that the motor vehicle is partly driven by the internal combustion engine 1, and is partly driven by the first electrical machine 20 as a further drive motor.

In the operating mode with load point shifting, a motor vehicle equipped with the hybrid drive assembly 200 is driven by the internal combustion engine 1, and the disconnect clutch 10 and the first clutch device 30 and/or second clutch device 60 are closed and the first electrical machine 20 driven by the internal combustion engine 1 is operated as a generator, and the electrical energy generated thereby is supplied to the battery for the purpose of storage.

In the case of a purely electric motor drive, the first electrical machine 20 is operated as an electric motor drive and the first clutch device 30 is closed. In recuperation operation, the output drive device 40 of the hybrid gear mechanism 3 is driven by the kinetic energy of the motor vehicle equipped with the hybrid drive assembly 200, wherein the first clutch device 30 is closed, and the first electrical machine 20 is operated as a generator.

With sole drive by the internal combustion engine 1, a motor vehicle equipped with the hybrid drive assembly 200 is driven by the internal combustion engine 1, wherein the disconnect clutch 10 and the first clutch device 30 or the second clutch device 60 is closed.

The hybrid gear mechanism proposed here and the claimed hybrid drive assembly provide for devices which ensure, in a cost-effective and space-saving manner, a large number of different modes of operating the hybrid drive assembly.

### LIST OF REFERENCE NUMBERS

1 Internal combustion engine
2 Vibration damper
3 Hybrid gear mechanism
4 Connection device
5 First spline
6 Branch
10 Disconnect clutch
11 Input side of the disconnect clutch
12 Output side of the disconnect clutch
20 First electrical machine
21 Stator
22 Rotor
23 Space radially enclosed by the rotor
24 Axis of rotation
30 First clutch device
31 Input side of the first clutch device
32 Output side of the first clutch device
33 Second spline
40 Output drive device
50 First torque transmission path
i1 First transmission stage
60 Second clutch device
61 Input side of the second clutch device
62 Output side of the second clutch device
63 Third spline
70 Second torque transmission path
i2 Second transmission stage
71 First gearwheel pair
72 Second gearwheel pair
73 Third gearwheel pair
80 Differential gear
100 First axle
101 Drive shaft
102 Wheel
200 Hybrid drive assembly
210 Second axle
220 Second electrical machine

1. A hybrid gear mechanism, comprising a connection device for coupling to an internal combustion engine, a disconnect clutch, a first electrical machine, a first clutch device and an output drive device of said hybrid gear mechanism, which are all interconnected in series, said connection device being mechanically coupled to an input side of the disconnect clutch, an output side of the disconnect clutch being coupled to a rotor of the first electrical machine, the rotor of the electrical machine being coupled to an input side of the first clutch device, and the output side of the first clutch device being coupled to the output drive device of the hybrid gear mechanism.

2. The hybrid gear mechanism according to claim 1, further comprising a second clutch device, which is arranged in a second torque transmission path running in parallel to a first torque transmission path which is defined by the disconnect clutch, the first electrical machine and the first clutch device.

3. The hybrid gear mechanism according to claim 2, wherein a first transmission stage is arranged in the first torque transmission path between the first clutch device and the output drive device, and a second transmission stage is arranged in the second torque transmission path between the second clutch device and the output drive device, wherein the second transmission stage implements a different transmission ratio than the first transmission stage.

4. The hybrid gear mechanism according to claim 3, wherein the output drive device is a differential gear.

5. The hybrid gear mechanism according to claim 2, wherein the first and second clutch devices are partial clutches of a dual clutch device.

6. The hybrid gear mechanism according to claim 2, wherein at least two of the disconnect clutch, the first clutch device and the second clutch device are arranged in an axial direction, in relation to an axis of rotation of the rotor of the first electrical machine, within a space which is radially enclosed by the rotor of the first electrical machine.

7. A hybrid drive assembly, comprising a hybrid gear mechanism according to claim 1, wherein the hybrid gear mechanism is assigned to a first axle of a motor vehicle to be driven, as well as a second electrical machine, which is assigned to a second axle and is electrically conductively connected to the first electrical machine in such a way that the second electrical machine can be operated at least indirectly by electrical energy generated by the first electrical machine.

8. The hybrid drive assembly according to claim 7, wherein the second electrical machine is designed as an electric drive axle on a rear axle of the motor vehicle.

9. The hybrid drive assembly according to claim 7, comprising an internal combustion engine, the output drive of which is mechanically coupled to the connection device of the hybrid gear mechanism.

10. (canceled)

11. A method for operating a hybrid drive assembly having a hybrid gear mechanism including a connection device for coupling to an internal combustion engine, a disconnect clutch, a first electrical machine, a second electrical machine, a first clutch device, a second clutch device, and an output drive device, the connection device being mechanically coupled to an input side of the disconnect clutch, an output side of the disconnect clutch being coupled to a rotor of the first electrical machine, the rotor of the first electrical machine being coupled to an input side of the first clutch device, and the output side of the first clutch device being coupled to the output drive device, the method comprising:
charging a battery when a motor vehicle equipped with the hybrid drive assembly is stationary, wherein the internal combustion engine is operated, the disconnect clutch is closed and the first electrical machine driven by the internal combustion engine is operated as a generator and electrical energy generated thereby is supplied to the battery for storage.

12. The method for operating the hybrid drive assembly according to claim 11, further comprising:
operating in a serial operation state, in which the internal combustion engine is operated, the disconnect clutch is closed and the first electrical machine is operated as a generator, and the electrical energy generated thereby is supplied to the second electrical machine for driving the motor vehicle.

13. The method for operating the hybrid drive assembly according to claim 11, further comprising:
operating in a parallel operation state, in which the motor vehicle equipped with the hybrid drive assembly is driven by the internal combustion engine, and the disconnect clutch and at least one of the first clutch device and second clutch device is closed, so that the motor vehicle is partly driven by the internal combustion engine, and the motor vehicle is partly driven by the first electrical machine as a further drive motor.

14. The method for operating the hybrid drive assembly according to claim 11, further comprising:
operating with load point shifting, in which a motor vehicle equipped with the hybrid drive assembly is driven by the internal combustion engine, and the disconnect clutch and at least one of the first clutch device and second clutch device is closed and the first electrical machine driven by the internal combustion engine is operated as a generator, and the electrical energy generated thereby is supplied to the battery for storage.

15. The method for operating the hybrid drive assembly according to claim 11, further comprising:
operating in a purely electric motor drive, in which the first electrical machine is operated as an electric motor drive and the first clutch device is closed.

16. The method for operating the hybrid drive assembly according to claim 11, further comprising:
operating in a recuperation operation state, in which the output drive device of the hybrid gear mechanism is driven by kinetic energy of the motor vehicle equipped with the hybrid drive assembly, the first clutch device is closed and the first electrical machine is operated as a generator.

17. The method for operating the hybrid drive assembly according to claim 11, further comprising:
operating in a sole drive state by the internal combustion engine, in which the motor vehicle equipped with the hybrid drive assembly is driven by the internal combustion engine, wherein the disconnect clutch and the first clutch device or the second clutch device is closed.
